(19) United States
(12) Patent Application Publication
(10) Pub. No.: US 2025/0097563 A1
(43) Pub. Date: Mar. 20, 2025

(54) DETECTION SYSTEM AND DETECTION METHOD FOR ELECTRONIC DEVICE

(71) Applicant: InnoLux Corporation, Miao-Li County (TW)

(72) Inventor: Kuang-Ming FAN, Miao-Li County (TW)

(21) Appl. No.: 18/805,801

(22) Filed: Aug. 15, 2024

Related U.S. Application Data
(60) Provisional application No. 63/583,872, filed on Sep. 20, 2023.

(30) Foreign Application Priority Data
Jun. 7, 2024 (CN) 202410736954.2

(51) Int. Cl. H04N 23/56; G01N 21/88; H04N 23/16

(52) U.S. Cl. CPC H04N 23/56; G01N 21/8806; H04N 23/16

(57) ABSTRACT

A detection system is provided. The detection system includes an optical detection module and a control module. The optical detection module includes a first light source, a second light source, and an image capturing component. The first light source provides a first light beam to illuminate an object to be measured. The second light source provides a second light beam to illuminate the object to be measured. The image capturing component is used to capture the object to be measured. The wavelength of the first light beam is different from the wavelength of the second light beam. The wavelength of either the first light beam or the second light beam is between 300 nanometers and 3000 nanometers. The control module receives and analyzes an image of the object to be measured obtained from the image capturing component to determine whether the object to be measured has a defect.

### CROSS REFERENCE TO RELATED APPLICATIONS

This application claims the benefit of China Application No. 202410736954.2, filed Jun. 7, 2024, which claims the benefit of provisional Application No. 63/583,872, filed Sep. 20, 2023, the entirety of which are incorporated by reference herein.

### BACKGROUND

### Technical Field

The present disclosure is related to a detection system and a detection method for an electronic device, and in particular it is related to a detection system and a detection method that improves the rate of defect detection.

### Description of the Related Art

Electronic devices such as tablet computers, notebook computers, smartphones, monitors, and televisions have become indispensable necessities in modern society. With the ongoing development of these portable electronic devices, consumers have high expectations regarding the quality, functionality or price of these products.

On the other hand, packaging technology can increase the integration density of electronic components (e.g., transistors, diodes, resistors, capacitors, etc.) in a given area, and has been widely used in the production and manufacturing of electronic devices in recent years. With the evolution of high-end packaging technology and the development of polymer material technology, detection methods that use visible light cannot effectively detect defects in some materials. For example, when these materials are located at the bottom of a structure, visible light cannot penetrate; or when these materials are located on the surface of a structure, the characteristics of high reflectivity or low transmittance of materials also makes it unable to detect visible light. However, if the optical non-destructive inspection system cannot be used immediately for quality management during the process of manufacturing electronic devices, it will cause a large loss in yield and production capacity.

Based on the information above, developing detection systems and detection methods for electronic devices that can improve the rate of defect detection is still one of the current research topics in the industry.

### SUMMARY

In accordance with some embodiments of the present disclosure, a detection system for an electronic device is provided. The detection system includes an optical detection module and a control module. The optical detection module includes a first light source, a second light source, and an image capturing component. The first light source provides a first light beam to illuminate an object to be measured. The second light source provides a second light beam to illuminate the object to be measured. The image capturing component is coupled to the first light source and the second light source and is used to capture an image of the object to be measured. The wavelength of the first light beam is different from the wavelength of the second light beam. The wavelength of either the first light beam or the second light beam is between 300 nanometers and 3000 nanometers. The control module is coupled to the optical detection module to control the first light source, the second light source and the image capturing component, and to receive and analyze an image of the object to be measured obtained from the image capturing component to determine whether the object to be measured has a defect.

In accordance with some embodiments of the present disclosure, a detection method for an electronic device is also provided. The detection method includes providing an object to be measured and using a detection system to detect the object to be measured. The detection system includes an optical detection module and a control module coupled to the optical detection module. The optical detection module includes a first light source, a second light source, and an image capturing component coupled to the first light source and the second light source. The control module receives and analyzes an image of the object to be measured obtained from the image capturing component. Furthermore, the detection method includes using a first light source to provide a first light beam to illuminate the object to be measured, and using a second light source to provide a second light beam to illuminate the object to be measured. The wavelength of the first light beam is different from the wavelength of the second light beam. The wavelength of either the first light beam or the second light beam is between 300 nanometers and 3000 nanometers. The detection method includes using the image capturing component to capture an image of the object to be measured, and using the control module to determine whether the object to be measured has a defect.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a block diagram of a detection system for an electronic device in accordance with some embodiments of the present disclosure;

FIG. 2A is a structural side view of an optical detection module in accordance with some embodiments of the present disclosure;

FIG. 2B is a structural side view of an optical detection module in accordance with some embodiments of the present disclosure;

FIG. 2C is a structural bottom view of a second light source of an optical detection module in accordance with some embodiments of the present disclosure;

FIG. 3 is a conceptual schematic diagram of an image capturing component performing multiple wavelength imaging in a single scan in accordance with some embodiments of the present disclosure.

### DETAILED DESCRIPTION

The detection system and detection method for the electronic device according to the present disclosure are described in detail in the following description. It should be understood that in the following detailed description, for purposes of explanation, numerous specific details and embodiments are set forth in order to provide a thorough understanding of the present disclosure. The elements and configurations described in the following detailed description are set forth in order to clearly describe the present disclosure. These embodiments are used merely for the purpose of illustration, and the present disclosure is not limited thereto. In addition, different embodiments may use like and/or corresponding numerals to denote like and/or corresponding elements in order to clearly describe the present disclosure. However, the use of like and/or corresponding numerals of different embodiments does not suggest any correlation between different embodiments.

It should be understood that relative expressions may be used in the embodiments. For example, “lower”, “bottom”, “higher” or “top” are used to describe the position of one element relative to another. It should be appreciated that if a device is flipped upside down, an element that is “lower” will become an element that is “higher”. The present disclosure can be understood by referring to the following detailed description in connection with the accompanying drawings. The drawings are also regarded as part of the description of the present disclosure. It should be understood that the drawings of the present disclosure may be not drawn to scale. In fact, the size of the elements may be arbitrarily enlarged or reduced to clearly represent the features of the present disclosure.

Furthermore, the expression “a first material layer is disposed on or over a second material layer” may indicate that the first material layer is in direct contact with the second material layer, or it may indicate that the first material layer is in indirect contact with the second material layer. In the situation where the first material layer is in indirect contact with the second material layer, there may be one or more intermediate layers between the first material layer and the second material layer. However, the expression “the first material layer is directly disposed on or over the second material layer” means that the first material layer is in direct contact with the second material layer, and there is no intermediate element or layer between the first material layer and the second material layer.

Moreover, it should be understood that the ordinal numbers used in the specification and claims, such as the terms “first”, “second”, etc., are used to modify an element, which itself does not mean and represent that the element (or elements) has any previous ordinal number, and does not mean the order of a certain element and another element, or the order in the manufacturing method. The use of these ordinal numbers is to ensure that an element with a certain name can be clearly distinguishable from another element with the same name. Claims and the specification may not use the same terms. For example, the first element in the specification may refer to the second element in the claims.

In accordance with the embodiments of the present disclosure, regarding the terms such as “connected to”, “interconnected with”, etc. referring to bonding and connection, unless specifically defined, these terms mean that two structures are in direct contact or two structures are not in direct contact, and other structures are provided to be disposed between the two structures. The terms for bonding and connecting may also include the case where both structures are movable or both structures are fixed. In addition, the term “electrically connected to” or “coupled to” may include any direct or indirect electrical connection means.

In the following descriptions, terms “about”, “substantially” and “approximately” typically mean +/−10% of the stated value, or typically +/−5% of the stated value, or typically +/−3% of the stated value, or typically +/−2% of the stated value, or typically +/−1% of the stated value or typically +/−0.5% of the stated value. The expression “in a range from the first value to the second value” or “between the first value and the second value” means that the range includes the first value, the second value, and other values in between. Moreover, certain errors may exist between any two values or directions used for comparison. If the first value is equal to the second value, it implies that there may be an error of about 10% between the first value and the second value; if the first direction is perpendicular to the second direction, the angle between the first direction and the second direction may be between 80degrees and 100 degrees; if the first direction is parallel to the second direction, the angle between the first direction and the second direction may be between 0 degrees and 10 degrees.

Moreover, in accordance with the embodiments of the present disclosure, an optical microscope (OM), a scanning electron microscope (SEM), a film thickness profiler (α-step), an ellipsometer or another suitable method may be used to measure the width, thickness, or height of each element, or distance or spacing between elements. Specifically, in accordance with some embodiments, a scanning electron microscope can be used to obtain cross-sectional images of the structure and measure the width, thickness, or height of each element, or distance or spacing between elements.

It should be understood that in the following embodiments, without departing from the spirit of the present disclosure, the features in several different embodiments can be replaced, recombined, and mixed to complete another embodiment. The features between the various embodiments can be mixed and matched arbitrarily as long as they do not violate or conflict the spirit of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In accordance with some embodiment of the present disclosure, a detection system and a detection method for an electronic device are provided, including an automatic detection method using multiple wavelengths and multiple light sources with a specific image capturing component, so that the detection light source can penetrate polymer materials in the structure and improve the ability to determine defects. The detection system and detection method provided by the embodiments of the present disclosure can perform real-time quality management through non-destructive testing during the process of manufacturing the electronic device, thereby improving the rate at which it can detect defects and increasing the process yield and production capacity of the electronic device.

In accordance with the embodiments of the present disclosure, the electronic device may include a power module, a semiconductor packaging device, a display device, a light-emitting device, a backlight device, an antenna device, a touch device, a sensing device, a wearable device, an automotive device, and a battery device or a tiled device, but the present disclosure is not limited thereto. The electronic device may be a bendable or flexible electronic device. The display device may be a non-self-luminous display device or a self-luminous display device. The antenna device may be a liquid-crystal type antenna device or a non-liquid-crystal type antenna device. The sensing device may be a sensing device that senses capacitance, light, heat energy or ultrasonic waves, but the present disclosure is not limited thereto. Furthermore, the electronic device may include, for example, liquid crystals, quantum dots (QDs), fluorescence, phosphorescence, other suitable materials, or a combination thereof. The electronic device may include electronic components, and the electronic components may include passive components and active components, such as capacitors, resistors, inductors, diodes, transistors, etc. The diode may include a light-emitting diode or a photodiode. The light-emitting diode may include, for example, an organic light-emitting diode (OLED), a mini light-emitting diode (mini LED), a micro light-emitting diode (micro LED) or a quantum dot light-emitting diode (quantum dot LED), but the present disclosure is not limited thereto. In accordance with some embodiments, the electronic device may include a panel and/or a backlight module. The panel may include, for example, a liquid-crystal panel or another self-luminous panel, but the present disclosure is not limited thereto. The tiled device may be, for example, a display tiled device or an antenna tiled device, but the present disclosure is not limited thereto. It should be understood that the electronic device can be any permutation and combination of the above, but the present disclosure is not limited thereto.

In accordance with the embodiments of the present disclosure, the detection system and detection method provided can be applied to any stage in the process of manufacturing an electronic device. For example, they can be applied to a wafer-level packaging (WLP) process, a panel-level package (PLP) process, or any process that requires real-time product inspection, but the present disclosure is not limited thereto.

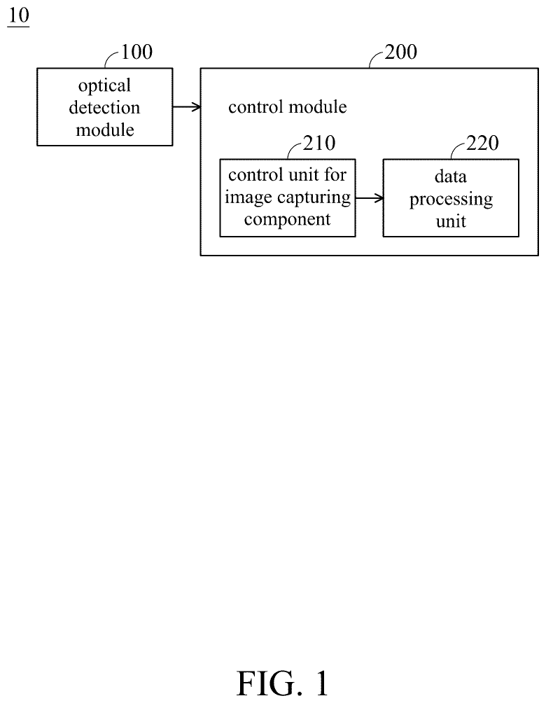

Please refer to FIG. 1, which is a block diagram of a detection system 10 for an electronic device in accordance with some embodiments of the present disclosure. As shown in FIG. 1, the detection system 10 for the electronic device includes an optical detection module 100 and a control module 200. The control module 200 is coupled to the optical detection module 100. In accordance with some embodiments, the control module 200 further includes an image capturing component control unit 210 and a data processing unit 220. The data processing unit 220 is coupled to the image capturing component control unit 210.

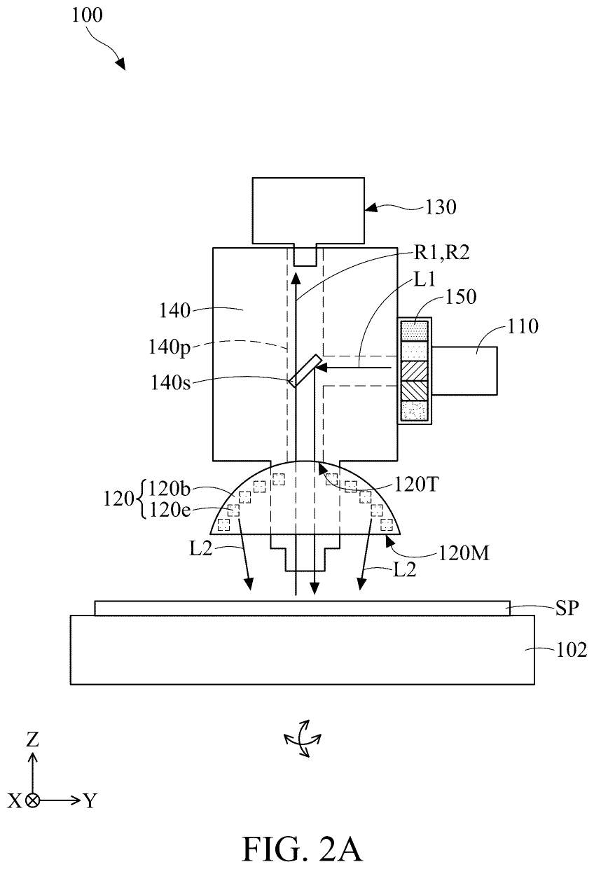

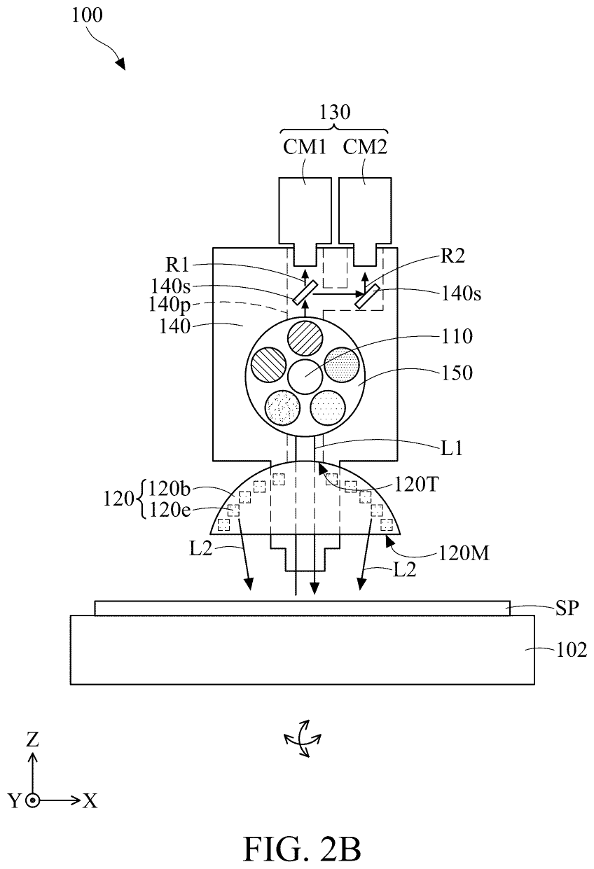

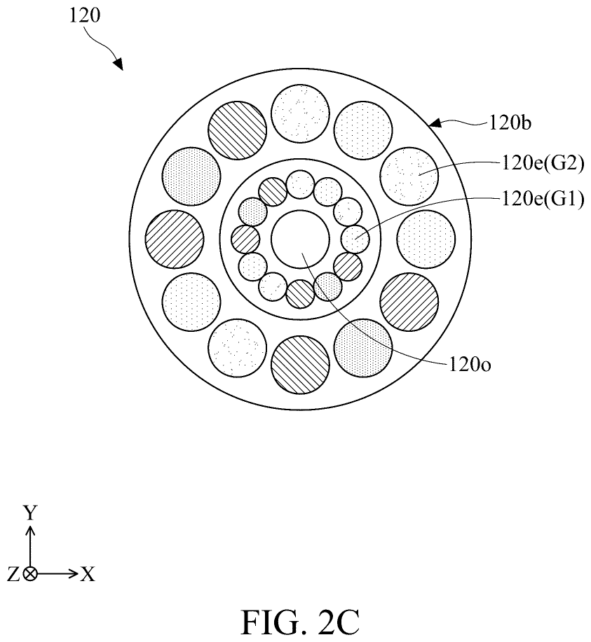

First, for the description of the optical detection module 100, please refer to FIG. 2A and FIG. 2B. FIG. 2A is a structural side view of the optical detection module 100 in accordance with some embodiments of the present disclosure. FIG. 2B is another structural side view of the optical detection module 100 in accordance with some embodiments of the present disclosure. It should be understood that, for clarity of explanation, some components of the optical detection module 100 may be omitted in the drawings, and only some components are schematically illustrated. In accordance with some embodiments, additional features may be added to the optical detection module 100 described below. In accordance with some other embodiments, some features of the optical detection module 100 described below may be replaced or omitted.

As shown in FIG. 2A and FIG. 2B, the optical detection module 100 may include a first light source 110, a second light source 120, an image capturing component 130 and an optical lens component 140. In accordance with some embodiments, the first light source 110 may be disposed on the side wall of the optical lens component 140, the second light source 120 may be disposed at the bottom of the optical lens component 140, and the image capturing component 130 may be disposed on the top of the optical lens component 140. In accordance with some embodiments, the optical detection module 100 may further include a carrier substrate 102, and an object to be measured SP may be disposed on the carrier substrate 102. In accordance with some embodiments, the angle or rotation of the carrier substrate 102 can be adjusted according to the X-Y plane, X-Z plane or Y-Z plane, so that there are more detection angle options between the light source and the object to be measured SP, and thus more precise detection results can be obtained.

The first light source 110 can provide a first light beam L1 to illuminate the object to be measured SP. The second light source 120 can provide a second light beam L2 to illuminate the object to be measured SP. The image capturing component 130 can be coupled to the first light source 110 and the second light source 120 and used to capture an image of the object to be measured SP.

Furthermore, the wavelength of the first light beam L1 provided by the first light source 110 is different from the wavelength of the second light beam L2 provided by the second light source 120. The wavelength of either the first light beam L1 or the second light beam L2 is between 300 nanometers and 3000 nanometers. In particular, the optical detection module 100 can increase the diversity of detection light sources through multiple light sources (for example, at least two light sources, the first light source 110 and the second light source 120) and the multiple wavelength ranges they provide, and can then be applied to the detection of more types of materials and improve the ability to determine defects.

Specifically, in accordance with some embodiments, the wavelength of the first light beam L1 provided by the first light source 110 may be between 300 nanometers and 3000 nanometers (i.e. 300 nm≤the wavelength of the first light beam L1≤3000 nm), for example, may be between 300 nanometers and 700 nanometers, or may be between 700 nanometers and 3000 nanometers, or between 700 nanometers and 1700 nanometers. In accordance with some embodiments, the wavelength of the second light beam L2 provided by the second light source 120 may be between 300 nanometers and 3000 nanometers (i.e. 300 nm≤the wavelength of the second light beam L2≤3000 nm), for example, may be between 300 nanometers and 700 nanometers, or between 700 nanometers and 3000 nanometers, or between 700 nanometers and 1700 nanometers. In other words, the first light beam L1 provided by the first light source 110 may be visible light or infrared light (for example, near-infrared light), and the second light beam L2 provided by the second light source 120 may also be visible light or infrared light (for example, near-infrared light).

In accordance with some embodiments, the wavelength of either the first light beam L1 or the second light beam L2 may be between 300 nanometers and 3000 nanometers, and the wavelength of the other of the first light beam L1 and the second light beam L2 may be between 300 nanometers and 700 nanometers. That is, the first light source 110 and the second light source 120 can be adjusted so that one of them provides visible light and the other provides infrared light, but the present disclosure is not limited thereto. In accordance with some other embodiments, the wavelengths of both the first light beam L1 and the second light beam L2 may be between 300 nanometers and 3000 nanometers. That is, the first light beam L1 and the second light beam L2 may both be infrared light. In accordance with some other embodiments, the wavelengths of the first light beam L1 and the second light beam L2 may both be between 300 nanometers and 700 nanometers. That is, the first light beam L1 and the second light beam L2 may both be visible light.

In addition, in accordance with some embodiments, the first light source 110 may provide a coaxial light source, and the second light source 120 may provide an annular dark field light source. In particular, the optical detection module 100 can further enhance the diversity of detection light sources by utilizing the characteristics of different types of light sources (such as coaxial light and dark field light), and thus can then be applied to the detection of more types of materials and improve the ability to determine defects.

In accordance with some embodiments, the optical lens component 140 has an optical path 140p, and the first light source 110 may provide the first light beam L1 via the optical path 140p. In addition, in accordance with some embodiments, the first light beam L1 irradiates the object to be measured SP to generate a first reflected light beam R1, and the second light beam L2 irradiates the object to be measured SP to generate a second reflected light beam R2. The first reflected light beam R1 and the second reflected light beam R2 may also be transmitted to the image capturing component 130 via the optical path 140p. In accordance with some embodiments, the optical lens component 140 may further include a beam splitter element 140s disposed in the optical path 140p. The beam splitter element 140s can split the incident light into two separate light beams in a specific ratio.

Specifically, as shown in FIG. 2B, in accordance with some embodiments, the image capturing component 130 may include a first photography device CM1 and a second photography device CM2, and the beam splitter element 140s of the optical lens component 140 may enable the first reflected light beam R1 and the second reflected light beam R2 to be correspondingly transmitted to the first photography device CM1 and the second photography device CM2. In accordance with some embodiments, the first reflected light beam R1 and the second reflected light beam R2 generated after irradiating the object to be measured SP can be mixed first, and then separated by the beam splitter element 140s and transmitted to the first photography device CM1 and the second photography device CM2, but the present disclosure is not limited thereto. In accordance with some other embodiments, the object to be measured SP can be irradiated separately to generate the first reflected light beam R1 and the second reflected light beam R2. The first reflected light beam R1 and the second reflected light beam R2 may, for example, be transmitted to the first photography device CM1 and the second photography device CM2 respectively without passing through the beam splitter element 140s. In accordance with some embodiments, the gray scale (degree) of the image or result presented by the first reflected light beam R1 using the first photography device CM1 is different in gray scale (degree) from the image or result presented by the second reflected light beam R2 using the second photography device CM2, or the gray scale (degree) ratio of the two is at least greater than or equal to 2, so as to facilitate identification.

Furthermore, although the optical lens component 140 includes two beam splitter elements 140s in the illustrated embodiments, the present disclosure is not limited thereto. In accordance with some other embodiments, the optical lens component 140 may include other suitable numbers of the beam splitter elements 140s. In addition, in accordance with some embodiments, the optical lens component 140 may further include other suitable optical elements that may adjust or facilitate beam transmission.

As described above, in accordance with some embodiments, the image capturing component 130 includes the first photography device CM1 and the second photography device CM2, and the first photography device CM1 and the second photography device CM2 can be used to receive light beams with different wavelength ranges. In particular, the optical detection module 100 can be equipped with light sources of multiple wavelengths to capture images in multiple wavelength ranges, so it can be applied to the detection of more types of materials and improve the ability to determine defects.

Specifically, in accordance with some embodiments, the first photography device CM1 can be used to receive a light beam with a wavelength between 300 nanometers and 900 nanometers. For example, the first photography device CM1 can receive a light beam with a wavelength between 300 nanometers and 700 nanometers, or between 700 nanometers and 900 nanometers. In accordance with some embodiments, the second photography device CM2 can be used to receive a light beam with a wavelength between 700 nanometers and 3000 nanometers. For example, the second photography device CM2 can receive a light beam with a wavelength between 700 nanometers and 1700 nanometers, or between 1700 nanometers and 3000 nanometers. In other words, the first photography device CM1 can receive a beam of visible light, and the second photography device CM2 can receive a beam of infrared light (e.g., near-infrared light).

In accordance with some embodiments, one of the first photography device CM1 and the second photography device CM2 may be used to receive a light beam with a wavelength between 300 nanometers and 900 nanometers, and the other may be used to receive a light beam with a wavelength between 700 nanometers and 3000 nanometers. That is, one of the first photography device CM1 and the second photography device CM2 receives a light beam in the visible light range, and the other receives a light beam in the infrared light range, but the present disclosure is not limited thereto.

In addition, the first photography device CM1 and the second photography device CM2 may be area-scan or line-scan type photography devices.

Furthermore, as shown in FIG. 2A and FIG. 2B, in accordance with some embodiments, the optical detection module 100 may further include a filter element 150, and the filter element 150 may be disposed between the first light source 110 and the optical lens component 140. The optical detection module 100 can use the filter element 150 to cause the first light source 110 to provide light beams with different wavelength ranges. In accordance with some embodiments, the filter element 150 may include a plurality of filter layers that filter different wavelength ranges, for example, a red filter layer, a green filter layer, a blue filter layer, a white filter layer or a yellow filter layer, etc., but the present disclosure is not limited thereto. In accordance with some embodiments, the position of the filter layer of the filter element 150 can be adjusted to overlap the traveling path of the first light beam L1 provided by the first light source 110 to provide the first light beam L1 with different wavelength ranges.

In addition, as described above, in accordance with some embodiments, the second light source 120 can provide an annular dark field light source. The structure of the second light source 120 is further described below. Please refer to FIG. 2A, 2B and 2C. FIG. 2C is a structural bottom view of the second light source 120 of the optical detection module 100 in accordance with some embodiments of the present disclosure.

In accordance with some embodiments, the second light source 120 may include a base 120b and a plurality of light-emitting elements 120e disposed on the base 120b. The plurality of light-emitting elements 120e may provide light beams with different wavelength ranges and different incident angles. In detail, the base 120b may be a cover with an arc shape or curvature. In accordance with some embodiments, the curvature of the surface of the base 120b may be between 10 degrees and 80 degrees. In addition, the top portion 120T of the base 120b may have an opening 1200, so that the first light beam L1 provided by the first light source 110, the first reflected light beam R1 generated by the first light beam L1 irradiating the object to be measured SP, and the second reflected light beam L2 generated by the second light beam L2 irradiating the object to be measured SP can be transmitted to the image capturing component 130.

Furthermore, a plurality of light-emitting elements 120e may be disposed on the inner surface of the base 120b. A part of the light-emitting elements 120e are disposed at a relatively high position of the base 120b, such as a position near the top portion 120T, and these light-emitting elements 120e (for clarity of explanation, labeled as light-emitting element G1 in FIG. 2C) can illuminate the object to be measured SP with a high-angle incident light beam. Moreover, another part of the light-emitting elements 120e are disposed at a relatively low position of the base 120b, such as a position near the bottom portion 120M, and these light-emitting elements 120e (for clarity of explanation, labeled as light-emitting element G2 in FIG. 2C) can illuminate the object to be measured SP with a low-angle incident light beam.

In addition, the plurality of light-emitting elements 120e may include lamp beads of multiple different colors, such as red, green, blue, white or yellow lamp beads, but the present disclosure is not limited thereto. The lamp beads of different colors can be arranged alternately. In accordance with some embodiments, the light-emitting element 120e may include a light-emitting diode (LED) or another suitable light-emitting element.

Please refer to FIG. 1 again. The control module 200 is coupled to the optical detection module 100 to control the first light source 110, the second light source 120 and the image capturing component 130, and to receive and analyze the image of the object to be measured SP obtained by the image capturing component to determine whether the object to be measured has a defect. In accordance with some embodiments, the control module 200 may include the image capturing component control unit 210 and the data processing unit 220 coupled to the image capturing component control unit 210. The image capturing component control unit 210 can be used to control the beam form provided by the first light source 110 and the second light source 120 and the wavelength range received by the image capturing component 130. Furthermore, the data processing unit 220 can establish a model through an algorithm, and the model can detect and classify defects.

In accordance with some embodiments, the image capturing component control unit 210 may include a computer that controls the optical detection module 100. Specifically, the image capturing component control unit 210 can control the wavelength range of the first light beam L1 provided by the first light source 110, the wavelength range and incident angle of the second light beam L2 provided by the second light source 120, and the wavelength range and frequency of the phase captured by the image capturing component 130 through an electronic control unit (ECU).

In accordance with some embodiments, the data processing unit 220 may include an artificial intelligence graphic processing unit server (AI GPU server), which may perform real-time detection and classification of images obtained by the image capturing component 130 through an edge computing system. In addition, if the image capturing component 130 acquires a large number of images, parallel computing can also be used to add AI GPU servers to enhance computing power. In accordance with some embodiments, the data processing unit 220 can perform defect detection and classification through rule-based machine learning algorithm and AI algorithm modeling. If the detection result of the algorithm shows that the confidence level is lower than 95%, it can be automatically assigned to an online operator for review, and the final determination results of the optical detection module 100 are automatically stored in the file server to achieve automated production.

In accordance with some embodiments of the present disclosure, a detection method for an electronic device is also provided, which includes providing an object to be measured SP and using the aforementioned detection system 10 for the electronic device to detect the object to be measured SP. Based on the above, the detection system 10 for the electronic device may include the optical detection module 100 and the control module 200 coupled to the optical detection module. The optical detection module 100 includes the first light source 110, the second light source 120 and the image capturing component 130 coupled to the first light source 110 and the second light source 120. The control module 200 can receive and analyze the image of the object to be measured SP obtained from the image capturing component 130. In accordance with some embodiments, the object to be measured SP may include, but is not limited to, a wafer, a packaged component, an electronic device with a through-hole substrate, a probe, a display, a light-emitting device, or any finished or semi-finished product in the manufacturing process.

Specifically, the detection method for the electronic device may include using the first light source 110 to provide the first light beam LI to illuminate the object to be measured SP, using the second light source 120 to provide the second light beam L2 to illuminate the object to be measured SP, and using the image capturing component 130 to capture an image of the object to be measured SP and using the control module 200 to determine whether the object to be measured SP has a defect.

As described above, the wavelength of the first light beam L1 is different from the wavelength of the second light beam L2, and the wavelength of either the first light beam L1 or the second light beam L2 may be between 300 nanometers and 300 nanometers. In accordance with some embodiments, the wavelength of the other of the first light beam L1 or the second light beam L2 may be between 300 nanometers and 700 nanometers. That is, the first light source 110 and the second light source 120 can be adjusted so that one of them provides visible light and the other provides infrared light, but the present disclosure is not limited thereto. Furthermore, in accordance with some embodiments, the first light source 110 may provide a coaxial light source, and the second light source 120 may provide an annular dark field light source.

In accordance with some embodiments, the first light beam L1 generates a first reflected light beam R1 after irradiating the object to be measured SP, the second light beam L2 generates a second reflected light beam R2 after irradiating the object to be measured SP and the first reflected light beam R1 and the second reflected light beam R2 are transmitted to the image capturing component 130.

As described above, in accordance with some embodiments, the image capturing component 130 may include the first photography device CM1 and the second photography device CM2. The first photography device CM1 and the second photography device CM2 may be used to receive light beams with different wavelength ranges. In accordance with some embodiments, one of the first photography device CM1 and the second photography device CM2 may be used to receive a light beam with a wavelength between 300 nanometers and 900 nanometers, and the other may be used to receive a light beam with a wavelength between 700 nanometers and 3000 nanometers. That is, of the first photography device CM1 and the second photography device CM2, one receives a light beam in the visible light range, and the other receives a light beam in the infrared light range, but the present disclosure is not limited thereto. In addition, a first photography device CM1 and a second photography device CM2 in the form of area-scan or line-scan may be used.

In accordance with some embodiments, the optical detection module 100 may further include the filter element 150, and the filter element 150 may be disposed between the first light source 110 and the optical lens component 140. The optical detection module 100 may use the filter element 150 to cause the first light source 110 to provide light beams with different wavelength ranges. In the detection method for the electronic device, the position of the filter layer of the filter element 150 can be adjusted (for example, turning a dial carrying multiple filter layers) to overlap the traveling path of the first light beam L1 provided by the first light source 110 to provide the first light beam L1 with different wavelength ranges.

Based on the foregoing, in accordance with some embodiments, the second light source 120 may include the base 120b and the plurality of light-emitting elements 120e disposed on the base 120b. In the detection method for the electronic device, the second light source 120 can provide light beams with different wavelength ranges and different incident angles by adjusting the light-emitting states of the plurality of light-emitting elements 120e. Specifically, in the detection method for the electronic device, the wavelength and incident angle of the second light beam L2 provided by the second light source 120 can be adjusted by adjusting the color, quantity and position of the light-emitting elements 120e.

Specifically, the control module 200 of the detection system 10 for the electronic device may include the image capturing component control unit 210 and the data processing unit 220 coupled to the image capturing component control unit. The image capturing component control unit 210 can control the beam form provided by the first light source 110 and the second light source 120 and the wavelength range received by the image capturing component 130. In detail, in the detection method for the electronic device, the wavelength range of the first light beam L1 provided by the first light source 110, the wavelength range and incident angle of the second light beam L2 provided by the second light source 120, and the wavelength range and frequency of phase acquisition, etc. of the image capturing component 130 can be controlled. Furthermore, in accordance with some embodiments, the image capturing component control unit 210 can control the first light source 110 and the second light source 120 to simultaneously provide the first light beam L1 and the second light beam L2, or control the first light source 110 or the second light source 120 to provide the first light beam L1 or the second light beam L2. In addition, the data processing unit 220 may establish a model through an algorithm, and the model can detect and classify defects.

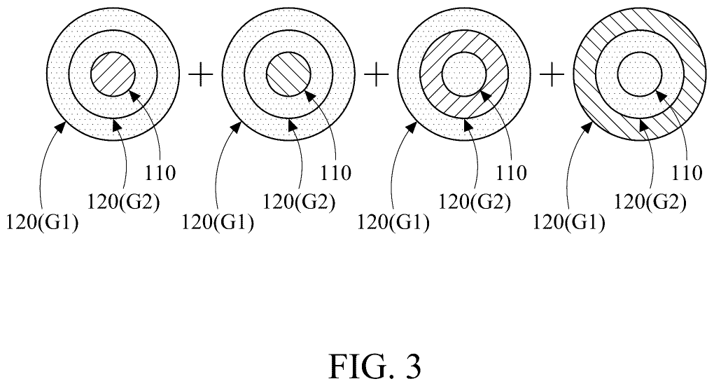

In particular, the image capturing component control unit 210 can control the beam form provided by the first light source 110 and the second light source 120 and the wavelength range received by the image capturing component 130, so that the image capturing component 130 can perform multi-wavelength imaging in a single scan. For example, please refer to FIG. 3, which is a conceptual schematic diagram of the image capturing component 130 performing multiple wavelength imaging in a single scan in accordance with some embodiments of the present disclosure. In FIG. 3, when the circle labeled as the first light source 110 has a diagonal pattern, it indicates that the first light source 110 emits light, and different diagonal patterns represent light of different wavelengths (colors); and when the circle labeled as the first light source 110 has a dot pattern, it indicates that the first light source 110 does not emit light. When the circle labeled as the second light source 120 (light-emitting element G1) has a diagonal pattern, it indicates that the light-emitting element 120e (G1) of the second light source 120 that provides a high-angle incident beam emits light, and different diagonal patterns represent light of different wavelengths (colors); and when the circle labeled as the second light source 120 (light-emitting element G1) has a dot pattern, it means that the light-emitting element G1 of the second light source 120 does not emit light. When the circle labeled as the second light source 120 (light-emitting element G2) has a diagonal pattern, it indicates that the light-emitting element 120e (G2) of the second light source 120 that provides a low-angle incident light beam emits light, and different diagonal patterns represent light of different color wavelengths (colors); and when the circle labeled as the second light source 120 (light-emitting element G2) has a dot pattern, it indicates that the light-emitting element G2 of the second light source 120 does not emit light.

As shown in FIG. 3, in accordance with some embodiments, referring to the leftmost schematic diagram, the image capturing component control unit 210 can be used to allow the first light source 110 to provide coaxial light (red light, for example) through the filter element 150 and to ensure the second light source 120 does not emit light. Referring to the second schematic diagram from the left, the image capturing component control unit 210 can be used to allow the first light source 110 to provide coaxial light (white light, for example) through the filter element 150, and to ensure the second light source 120 does not emit light. Referring to the third schematic diagram from the left, the image capturing component control unit 210 can be used to make sure that the first light source 110 does not emit light, and to allow the second light source 120 to provide an annular dark field light (annular red light, for example) through the light-emitting element G2 that provides a low-angle incident light beam, while the light-emitting element G1 that provides a high-angle incident light beam does not emit light. Referring to the fourth schematic diagram from the left, the image capturing component control unit 210 can be used to make sure that the first light source 110 does not emit light, and to ensure that the second light source 120 provides annular dark field light (annular blue light, for example) through the light-emitting element G1 that provides a high-angle incident light beam, while the light-emitting element G2 that provides a low-angle incident light beam does not emit light.

It should be noted that the above four kinds of images can be obtained using a single scan of the image capturing component 130. Through the combination of these images from different light sources and wavelengths, the detection method for the electronic device can be applied to the detection of various types of materials and improve the ability to determine defects.

In addition, it should be understood that FIG. 3 is only a conceptual diagram of multi-wavelength imaging, and the beam forms provided by the first light source 110 and the second light source 120 are not limited thereto. In accordance with different embodiments, the image capturing component control unit 210 can control other combined beam forms provided by the first light source 110 and the second light source 120 and adjust the wavelength range received by the image capturing component 130.

To summarize the above, in accordance with the embodiments of the present disclosure, the detection system and detection method for an electronic device are provided, including an automatic detection method using multiple wavelengths and multiple light sources with a specific image capturing component, so that the detection light source can penetrate polymer materials in the structure and improve the ability to determine defects. The detection system and detection method provided by the embodiments of the present disclosure can perform real-time quality management through non-destructive testing during the process of manufacturing the electronic device, thereby improving the defect detection rate and increasing the process yield and production capacity of the electronic device.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Thus, the appended claims are intended to include within their scope such processes, machines, manufacture, compositions of matter, means, methods or steps. Moreover, each claim constitutes an individual embodiment, and the claimed scope of the present disclosure includes the combinations of the claims and embodiments. The scope of protection of the present disclosure is subject to the definition of the scope of the appended claims. Any embodiment or claim of the present disclosure does not need to meet all the purposes, advantages, and features disclosed in the present disclosure.

What is claimed is:

1. A detection system for an electronic device, comprising:
an optical detection module, comprising:
a first light source that provides a first light beam to illuminate an object to be measured;
a second light source that provides a second light beam to illuminate the object to be measured; and
an image capturing component coupled to the first light source and the second light source and used to capture an image of the object to be measured,
wherein a wavelength of the first light beam is different from a wavelength of the second light beam, and the wavelength of either the first light beam or the second light beam is between 300 nanometers and 3000 nanometers; and
a control module coupled to the optical detection module and used to control the first light source, the second light source and the image capturing component, wherein the control module receives and analyzes an image of the object to be measured obtained from the image capturing component to determine whether the object to be measured has a defect.

2. The detection system for an electronic device as claimed in claim 1, wherein the optical detection module further comprises:
an optical lens component having an optical path, wherein the first light source provides the first light beam through the optical path.

3. The detection system of an electronic device as claimed in claim 2, wherein the first light beam irradiates the object to be measured to generate a first reflected light beam, and the second light beam irradiates the object to be measured to generate a second reflected light beam, and the first reflected light beam and the second reflected light beam are transmitted to the image capturing component through the optical path.

4. The detection system of an electronic device as claimed in claim 1, wherein the wavelength of the other of the first light beam or the second light beam is between 300 nanometers and 700 nanometers.

5. The detection system for an electronic device as claimed in claim 1, wherein the image capturing component comprises a first photography device and a second photography device, wherein the first photography device and the second photography device are used to receive light beams with different wavelength ranges.

6. The detection system for an electronic device as claimed in claim 3, wherein the image capturing component comprises a first photography device and a second photography device, and the optical lens component further comprises a beam splitter element disposed in the optical path, and the beam splitter element allows the first reflected light beam and the second reflected light beam to be correspondingly transmitted to the first photography device and the second photography device.

7. The detection system for an electronic device as claimed in claim 2, wherein the optical detection module further comprises:
a filter element disposed between the first light source and the optical lens component.

8. The detection system for an electronic device as claimed in claim 1, wherein the first light source provides a coaxial light source.

9. The detection system for an electronic device as claimed in claim 1, wherein the second light source provides an annular dark field light source.

10. The detection system for an electronic device as claimed in claim 1, wherein the second light source comprises a base and a plurality of light-emitting elements disposed on the base, and the plurality of light-emitting elements provide light beams with different wavelength ranges and different incident angles.

11. The detection system for an electronic device as claimed in claim 1, wherein the control module comprises:
an image capturing component control unit; and
a data processing unit coupled to the image capturing component control unit, wherein the data processing unit establishes a model through an algorithm, and the model detects and classifies defects.

12. The detection system of an electronic device as claimed in claim 11, wherein the image capturing component control unit is used to control the beam form provided by the first light source and the second light source and the wavelength range received by the image capturing component. 13. A detection method for an electronic device, comprising:
providing an object to be measured; 2
using a detection system to detect the object to be measured, wherein the detection system comprises an optical detection module and a control module coupled to the optical detection module, the optical detection module comprises a first light source, a second light source and an image capturing component coupled to the first light source and the second light source, and the control module receives and analyzes an image of the object to be measured obtained from the image capturing component,
wherein the detection method for an electronic device comprises:
using the first light source to provide a first light beam to illuminate the object to be measured;
using the second light source to provide a second light beam to illuminate the object to be measured, wherein a wavelength of the first light beam is different from a wavelength of the second light beam, and the wavelength of either the first light beam or the second light beam is between 300 nanometers and 3000 nanometers;
using the image capturing component to capture an image of the object to be measured; and
using the control module to determine whether the object to be measured has a defect.

14. The detection method for an electronic device as claimed in claim 13, wherein the first light beam irradiates the object to be measured to generate a first reflected light beam, and the second light beam irradiates the object to be measured to generated a second reflected light beam, and the first reflected light beam and the second reflected light beam are transmitted to the image capturing component.

15. The detection method of an electronic device as claimed in claim 13, wherein the image capturing component comprises a first photography device and a second photography device, wherein the first photography device and the second photography device receive light beams with different wavelength ranges.

16. The detection method of an electronic device as claimed in claim 13, wherein the optical detection module further comprises a filter element disposed between the first light source and an optical lens component, and the filter element allows the first light source to provide light beams with different wavelength ranges.

17. The detection method of an electronic device as claimed in claim 13, wherein the second light source comprises a base and a plurality of light-emitting elements disposed on the base, and the light-emitting states of the light-emitting elements are adjusted to allow the second light source to provide light beams with different wavelength ranges and different incident angles.

18. The detection method of an electronic device as claimed in claim 13, wherein the control module comprises an image capturing component control unit and a data processing unit coupled to the image capturing component control unit, wherein the data processing unit establishes a model through an algorithm, and the model detects and classifies defects.

19. The detection method of an electronic device as claimed in claim 18, wherein the image capturing component control unit controls the beam form provided by the first light source and the second light source and the wavelength range received by the image capturing component so that the image capturing component performs multi-wavelength imaging in a single scan.

20. The detection method of an electronic device as claimed in claim 19, wherein the image capturing component control unit controls the first light source and the second light source to simultaneously provide the first light beam and the second light beam, or the image capturing component control unit controls the first light source or the second light source to provide the first light beam or the second light beam.
